(19) United States
(12) Patent Application Publication
(10) Pub. No.: US 2023/0325924 A1
(43) Pub. Date: Oct. 12, 2023

(54) METHODS AND SYSTEMS FOR PROVIDING A USER WITH A PROPRIETARY ASSET CORRESPONDING TO A NAME, IMAGE AND LIKENESS (NIL) OF A COLLEGE ATHLETE

(71) Applicant: MALK HOLDINGS, LLC, DALLAS, TX (US)

(72) Inventors: Michael W. Shore, Dallas, TX (US); Alfonso G. Chan, Colleyville, TX (US); Luis M. Ortiz, Albuquerque, MN (US); Kermit D. Lopez, Albuquerque, NM (US)

(21) Appl. No.: 17/956,252

(22) Filed: Sep. 29, 2022

Related U.S. Application Data
(60) Provisional application No. 63/252,543, filed on Oct. 5, 2021.

(51) Int. Cl. G06Q 40/06

(52) U.S. Cl. CPC G06Q 40/06

(57) ABSTRACT

Methods and systems for providing a user with a proprietary asset corresponding to a name, image or likeness (NIL) of a college athlete, can involve allowing a user through a user interface to choose to affiliate an NIL identifier(s) in a relational database with a user transaction, wherein the user transaction is associated through the relational database to the NIL identifier(s) so that a college athlete(s) respectively associated with the NIL identifier(s) can receive a financial benefit from the user transaction. As a result of the user transaction, the user can be permitted to receive an NIL benefit from the college athlete(s), the NIL benefit including, for example, a non-fungible token image of the college athlete(s), a digital image of the college athlete(s), a likeness of the college athlete(s), a communication from or on behalf of the college athlete(s), and so on.

### CROSS REFERENCE TO PROVISIONAL APPLICATION

This patent application claims priority under 35 U.S.C. § 119 to U.S. Provisional Patent Application Ser. No. 63/252,543 entitled “Methods and Systems for Providing a User with a Proprietary Asset Corresponding to a Name, Image, and Likeness (NIL) of a College Athlete,” which was filed on Oct. 5, 2021, and is incorporated herein by reference in its entirety.

### TECHNICAL FIELD

Embodiments are related to methods and systems for providing a user with a proprietary benefit or asset comprising a name, image and likeness (NIL) of a college athlete. Embodiments also relate to mobile applications and relational databases.

### BACKGROUND

For many years, the National Collegiate Athletic Association (NCAA) prohibited college athletes from both maintaining their amateur status and profiting from their name, image and/or likeness (NIL). That is, profiting from one's NIL was considered a form of professionalism forbidden by NCAA rules. The NCAA considered any NIL activity by an athlete a form of financial compensation for athletic activity. This changed, however, in response to the U.S. Supreme Court ruling in NCAA vs. Alston. In Alston, the Court ruled that the NCAA could not bar member schools from offering certain education-related benefits to student-athletes. Although student-athletes profiting off their NIL was a separate issue, the 9-0 ruling in in NCAA vs. Alston prompted the NCAA to drop its resistance college athletes profiting from their NIL in certain circumstances.

NCAA policy now includes guidelines that allow college athletes to engage in NIL activities that are consistent with the laws of the states where the schools are located. Colleges and universities may be a resource for state law questions. College athletes who attend a school in a state without an NIL law can engage in this type of activity without violating NCAA rules related to NIL. College athletes can also use a professional services provider for NIL activities. In addition, the new NCAA NIL policy indicates that student-athletes should report NIL activities to various entities consistent with state law or school and conference requirements.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, an aspect of the embodiments to provide for providing a user with a proprietary asset corresponding to a NIL of a college athlete, to enable real time or near real time reporting of NIL transactions and activity and to do this without encumbering the college athlete with time-consuming and complicated reporting and NIL activities that take from the college athlete's abilities to both compete at the highest level in their chosen sport and academically.

It is another aspect of the embodiments to provide for an improved user interface for providing a user with a proprietary asset corresponding to a NIL of a college athlete.

The aforementioned aspects and other objectives and advantages can now be achieved as described herein. In an embodiment, a method for providing a user with a proprietary asset corresponding to a name, image or likeness (NIL) of a college athlete, can involve: creating a relational database associating at least one NIL of at least one college athlete among a plurality of athletes respectively with at least one NIL identifier; allowing a user through a user interface to choose to affiliate the at least one NIL identifier in the relational database with a user transaction, wherein the user transaction is associated through the relational database to the at least one NIL identifier so that the at least one college athlete respectively associated with the at least one NIL identifier receives a financial benefit from or associated with the user transaction; and as a result of (or in response to) the user transaction, permitting the user to receive an NIL benefit from the at least one college athlete, the NIL benefit including at least one of: a non-fungible token image or likeness of the at least one college athlete, a digital image or likeness of the at least one college athlete, a communication from or on behalf of the at least one college athlete, an autograph, clothing, a discount on the user transaction or future transactions, or a social media post by or on behalf of the at least one college athlete associated with the user transaction.

In an embodiment, the relational database can be operable to track a total number of NIL transactions and/or NIL benefits based on a cumulative number or value of the NIL transactions.

In an embodiment, the user interface can provide at least one screen operable to display electronic content about the at least one college athlete, the electronic content including a NIL associated with the at least one college athlete.

In an embodiment, the user interface can graphically display an object that when selected by the user, allows the user to affiliate the at least one NIL identifier with the user transaction.

In an embodiment, the object can be displayed in the user interface in a shape of a NIL representative of the at least one college athlete.

In an embodiment, the object can occupy a user-specified location on a screen of the user interface and/or can occupy a user specified area of the user interface.

In an embodiment, the NIL benefit can comprise at least one of the digital image of the athlete or the likeness of the at least one college athlete is displayable on a lock screen of the user interface.

An embodiment can further involve preventing a display of the at least one of the digital image of the at least one college athlete or the likeness of the at least one college athlete on any screen of the user interface without the NIL benefit.

An embodiment can further involve facilitating the user transaction with a menu that respectively displays the at least one NIL identifier in association with one or more menu items in the menu.

An embodiment can further involve authorizing at least one NIL identifier among a plurality of NIL identifiers in the relational database to be stored in a memory accessible by a mobile app associated with the user, wherein the mobile app provides the user interface.

In an embodiment, the user transaction can include one or more of: a past transaction or a current transaction.

In an embodiment, the communication from or on behalf of the at least one college athlete can comprise a pre-determined and pre-recorded message from the at least one college athlete.

In an embodiment, a method for providing a user with a proprietary asset corresponding to a name, image or likeness (NIL) of a college athlete, can involve: allowing a user through a user interface to choose to affiliate at least one NIL identifier in a relational database with a user transaction, wherein the user transaction is associated through the relational database to the at least one NIL identifier so that at least one college athlete respectively associated with the at least one NIL identifier receives a financial benefit from the user transaction; and as a result of (or in response to) the user transaction, permitting the user to receive an NIL benefit from the at least one college athlete, the NIL benefit including at least one of: a non-fungible token image of the at least one college athlete, a digital image of the at least one college athlete, a likeness of the at least one college athlete, a communication from or on behalf of the at least one college athlete, clothing, a discount on the user transaction or future transactions, or a social media post by or on behalf of the at least one college athlete associated with the user transaction.

An embodiment can further involve creating the relational database associating at least one NIL of the at least one college athlete among the plurality of athletes respectively with the at least one NIL identifier.

In an embodiment, a system for providing a user with a proprietary asset corresponding to a name, image or likeness (NIL) of a college athlete, can comprise: a relational database associating at least one NIL of at least one college athlete among a plurality of athletes respectively with at least one NIL identifier; a user interface, wherein a user is allowed through the user interface to choose to affiliate the at least one NIL identifier in the relational database with a user transaction, wherein the user transaction is associated through the relational database to the at least one NIL identifier so that the at least one college athlete respectively associated with the at least one NIL identifier receives a financial benefit from the user transaction; and an NIL benefit, wherein as a result of (or in response to) the user transaction, the user is permitted to receive an NIL benefit from the at least one college athlete, the NIL benefit including at least one of: a non-fungible token image or likeness of the at least one college athlete, a digital image or likeness of the at least one college athlete, a communication from or on behalf of the at least one college athlete, clothing, a discount on the user transaction or future transactions, or a social media post by or on behalf of the at least one college athlete associated with the user transaction.

In an embodiment, a system for providing a user with a proprietary asset corresponding to a name, image or likeness (NIL) of a college athlete, can comprise: at least one processor; at least one memory storing at least one program for execution by the at least one processor, the at least one processor including instructions for: creating a relational database associating at least one NIL of at least one college athlete among a plurality of athletes respectively with at least one NIL identifier; allowing a user through a user interface to choose to affiliate the at least one NIL identifier in the relational database with a user transaction, wherein the user transaction is associated through the relational database to the at least one NIL identifier so that the at least one college athlete respectively associated with the at least one NIL identifier receives a financial benefit from the user transaction; and as result of (or in response to) the user transaction, permitting the user to receive an NIL benefit from the at least one college athlete, the NIL benefit including at least one of: a non-fungible token image or likeness of the at least one college athlete, a digital image or likeness of the at least one college athlete, a communication from or on behalf of the at least one college athlete, clothing, a discount on the user transaction or future transactions, or a social media post by or on behalf of the at least one college athlete associated with the user transaction.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a block diagram of an example system for providing a user with a proprietary asset corresponding to a NIL of a college athlete, in accordance with an embodiment;

FIG. 2 illustrates an example graphical user interface and screen of a NIL application that can be presented on a display of a user device, in accordance with an embodiment;

FIG. 3 illustrates a flow chart of operations depicting logical operational steps of a method for providing a user with a proprietary asset corresponding to a name, image or likeness (NIL) of a college athlete, in accordance with an embodiment;

FIG. 4 illustrates a flow chart of operations depicting additional logical operational steps of a method for providing a user with a proprietary asset corresponding to a name, image or likeness (NIL) of a college athlete, in accordance with an embodiment;

FIG. 5 illustrates a block diagram of the system for providing a user with a proprietary asset corresponding to a name, image or likeness (NIL) of a college athlete, in accordance with an embodiment;

FIG. 6 illustrates an example graphical user interface and screen of the NIL application that can be presented on a display of user device, in accordance with an embodiment;

FIG. 7 illustrates a block diagram of an example computing device that can implement the features, methods, systems, and processes of FIGS. 1-6;

FIG. 8 illustrates a schematic diagram of the system of FIG. 1 and FIG. 5 for providing a user with a proprietary asset corresponding to a NIL, as applied to a restaurant, in accordance with an embodiment; and

FIG. 9 illustrates a block diagram of the system of FIG. 1 and FIG. 5, in accordance with an alternative embodiment.

### DETAILED DESCRIPTION

The particular values and configurations discussed in these non-limiting examples can be varied and are cited merely to illustrate one or more embodiments and are not intended to limit the scope thereof.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be interpreted in a limiting sense.

Throughout the specification and claims, terms may have nuanced meanings suggested or implied in context beyond an explicitly stated meaning. Likewise, phrases such as “in one embodiment” or “in an example embodiment” and variations thereof as utilized herein do not necessarily refer to the same embodiment and the phrase “in another embodiment” or “in another example embodiment” and variations thereof as utilized herein may or may not necessarily refer to a different embodiment. It is intended, for example, that claimed subject matter include combinations of example embodiments in whole or in part.

In general, terminology may be understood, at least in part, from usage in context. For example, terms such as “and,” “or,” or “and/or” as used herein may include a variety of meanings that may depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms such as “a,” “an,” or “the”, again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “at least one” as utilized can mean “one or more”. For example, “at least one widget” may mean the same as “one or more widgets”. Likewise, the term “a plurality of” may refer to “a group of”. For example, “a plurality of widgets” may have the same meaning as “a group of widgets”.

The term “data” as utilized herein can relate to physical signals that indicate or include information. The term “image” as utilized herein can relate to a pattern of physical light or a collection of data representing the physical light, which may include characters, words, and text as well as other features such as graphics. The term “digital image” as utilized herein can relate to, by extension an image represented by a collection of digital data. An image may be divided into “segments,” each of which is itself an image. A segment of an image may be of any size up to and including the whole image.

In a digital image composed of data representing physical light, each element of data may be called a “pixel,” which is common usage in the art and refers to a picture element. Each pixel has a location and value. Each pixel value is a bit in a “binary form” of an image, a gray scale value in a “gray scale form” of an image, or a set of color space coordinates in a “color coordinate form” of an image, the binary form, gray scale form, and color coordinate form each being a two-dimensional array defining an image.

The term “user interface” as utilized herein can relate to the point at which human users can interact with a computer, website or application (e.g., such as a mobile ‘app’). A goal of an effective user interface (UI) is to make the user's experience easy and intuitive, requiring minimum effort on the user's part to receive maximum desired outcome. The user interface can be created in layers of interaction that can appeal to the human senses (e.g., sight, touch, auditory and more). A client device such as a mobile device (e.g., a smartphone, a tablet computing device, a smart watch, or other computing devices, etc.) can include one or more applications that can provide a UI that allows a user to utilize services from network service providers.

The term “user” as utilized herein can relate to a person who utilizes a computer or network service. A user often has a user account and can be identified to the system (e.g., system 100) by a username. Other terms for username may include login name, screenname, account name, nickname and handle. A “user” may also be a customer, consumer, a sports fan, a user of a user device such as the user device 130, a user of a system such as system 100 herein, and so on.

A UI may include both input devices like keyboard, mouse, trackpad, microphone, touch screen, fingerprint scanner, e-pen and camera and output devices like monitors, speakers and printers. Devices that can interact with multiple senses may be referred to as “multimedia user interfaces”. For example, an everyday UI can use a combination of tactile input (keyboard and mouse) and a visual and auditory output (monitor and speakers).

Examples of user interfaces include but are not limited to a form-based user interface, a graphical user interface (GUI), a menu-driven user interface, a touch user interface, and a voice user interface. A form-based user interface can be used to enter data into a program or application by offering a limited selection of choices. For example, a settings menu on a device is form-based. A graphical user interface is a tactile UI input with a visual UI output (e.g., keyboard and monitor). A menu-driven user interface is a UI that can use a list of choices to navigate within a program or website. For example, ATMs use menu-driven UIs and are easy for anyone to use. A touch user interface is a user interface that involves haptics or touch. Most smartphones, tablets and any device that operates using a touch screen use haptic input. A voice user interface facilitates interactions between humans and machines using auditory commands. Examples include virtual assistant devices, talk-to-text, GPS and much more.

The term “object” as used herein relates to objects displayed by a user interface. That is, a user interface can display objects that can convey information and can represent actions that can be taken by the user. The objects can, for example change color, size, or visibility when the user interacts with them. The term “object” can also relate to GUI objects, which are GUI elements such as icons, cursors, buttons, and so on. These GUI elements may be implemented with sounds, or visual effects like transparency and drop shadows, and in some instances can be displayed in a particular shape or image, such as, for example, a name, likeness or an image (e.g., a digital image) of a subject (e.g., a person, a place, etc.). Using these objects, a user can use the computing device without having to know commands.

This disclosure describes various Graphical User Interfaces (GUIs) for implementing various features, processes or workflows. These GUIs can be presented on a variety of electronic devices including but not limited to laptop computers, desktop computers, computer terminals, television systems, tablet computers, e-book readers and smart phones. One or more of these electronic devices can include a touch-sensitive surface. The touch-sensitive surface can process multiple simultaneous points of input, including processing data related to the pressure, degree or position of each point of input. Such processing can facilitate gestures with multiple fingers, including pinching and swiping.

When the disclosure refers to “select” or “selecting” or “choosing” user interface elements in a GUI, these terms can be understood to include clicking or “hovering” with a mouse or other input device over a user interface element, or touching, tapping or gesturing with one or more fingers or stylus on a user interface element. User interface elements can be virtual buttons, menus, selectors, switches, sliders, scrubbers, knobs, thumbnails, links, icons, radio buttons, checkboxes and any other mechanism for receiving input from, or providing feedback to a user.

The embodiments disclosed herein include methods and systems for providing a user with a proprietary asset corresponding to a name, image or likeness (NIL) of a college athlete. The embodiments involve allowing a user through a user interface to choose to affiliate an NIL identifier(s) in a relational database with a user transaction, wherein the user transaction is associated through the relational database to the NIL identifier(s) so that a college athlete(s) respectively associated with the NIL identifier(s) can receive a financial benefit from the user transaction. As a result of the user transaction, the user can be permitted to receive an NIL benefit from the college athlete(s), the NIL benefit including, for example, a non-fungible token image of the college athlete(s), a digital image of the college athlete(s), a likeness of the college athlete(s), a communication from or on behalf of the college athlete(s), clothing, a discount on the user transaction or future transactions, or a social media post by or on behalf of the college athlete(s) associated with the user transaction, and so on. Note that the term ‘user transaction’ as utilized herein can relate to a present transaction and/or a future transaction.

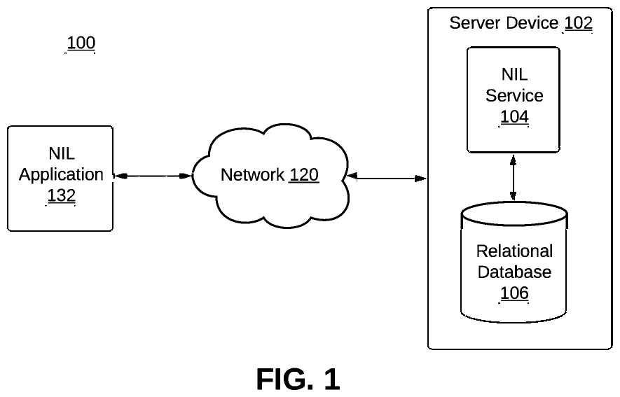

FIG. 1 illustrates a block diagram of a system 100 for providing a user with a proprietary asset corresponding to a NIL of a college athlete, in accordance with an embodiment. Note that as utilized herein, the acronym ‘NIL’ refer to a “name, image, or likeness’ or to a “name, image and likeness”. In some implementations, system 100 can include a server device 102. For example, the server device 102 can be a computing device or multiple computing devices associated with a NIL services provider. Server device 102 can correspond to well-known server hardware architectures and can include processors for performing operations for providing a proprietary asset corresponding to a NIL of a college athlete.

In some implementations, the server device 102 can include a NIL service 104. For example, NIL service 104 can be a software server that provides backend processing for a NIL service provider. The NIL service 104 can, for example, provide a user with a proprietary asset corresponding to a name, image or likeness (NIL) of a college athlete, and also create or facilitate the creation of a relational database 106 that can associate at least one NIL of at least one college athlete among a plurality of athletes respectively with at least one NIL identifier and send NIL data to various client devices (e.g., user device 130) so that the client devices can present NIL data to the users of the client devices. For example, NIL service 104 can send data to a client device while the client device is connected to server device 102 through network 120 (e.g., the Internet). The client device can present the data to the user using a mobile application (“app”) on the client device.

Note that the term “relational database” as utilized herein can relate to a type of database that can store and provide access to data points that related to one another. A relational database can be based on the relational model, an intuitive, straightforward way of representing data in tables. In a relational database, each row in the table can be a record with a unique ID called the key. The columns of the table hold attributes of the data, and each record usually has a value for each attribute, making it easy to establish the relationships among data points. A non-limiting example of a relational database and a relational database architecture, which can be used to implement the relational database 106 is disclosed in U.S. Pat. No. 11,120,024 entitled “Dual-stack architecture that integrates relational database with blockchain,” which issued on Sep. 14, 2021 and is incorporated herein by reference in its entirety. Another non-limiting example of a relational database 106 is disclosed in U.S. Pat. No. 11,080,300 entitled “Using relation suggestions to build a relational database,” which issued on Aug. 3, 2021 and is incorporated herein by reference in its entirety.

In some implementations, the user device 130 can be a computing device, such as a laptop computer, smart phone, tablet computer, and the like. User device 130 can be a wearable device, such as a smartwatch, smart glasses, etc. User device 130 can be a media device, such as a streaming media device, media player, automobile entertainment system, etc. The user device 130 can be a client device that can connect to network 120 to obtain NIL data, as described herein. Note that NIL data can include information such as NIL identifiers and information related to college athletes.

In some implementations, user device 130 can include the NIL application 132. For example, NIL application 132 can provide features that allow the user to search for and/or specify a particular college athlete or a group of college athletes among a plurality of athletes and can also allow the user through a user interface to choose to affiliate one or more NIL identifiers in the relational database 106 with a user transaction. Note that the term ‘transaction’ as utilized herein can relate to an electronic transaction and in particular to a financial transaction. An electronic transaction can involve the sale or purchase of goods or services, whether between businesses, households, individuals, governments, and other public or private organizations, conducted over computer-mediated networks, such as, for example, the network 120 shown in FIG. 1.

In one implementation, the NIL application 132 can allow the user to search through a user interface to choose to affiliate the NIL identifier(s) in the relational database with a user transaction, wherein the user transaction is associated through the relational database 106 to the NIL identifier(s) so that college athlete(s) respectively associated with the NIL identifier(s) can receive a financial benefit from the user transaction. This feature allows the college athlete to profit from his or her NIL. The NIL application 132 can also provide features that allow the user to view representations of college athletes on a user interface screen, along with other information such as, for example, a graphically displayed menu with menu items associated with particular college athletes and associated NIL information.

The NIL application 132 can receive user input requesting, for example, the aforementioned user transaction. Moreover, the NIL application 132 can, as a result of the user transaction, permit the user to receive an NIL benefit from the at least one college athlete, the NIL benefit including one or more of, for example, a non-fungible token image or likeness of the at least one college athlete, a digital image or likeness of the at least one college athlete, a communication from or on behalf of the at least one college athlete, clothing, a discount on the user transaction or future transactions, or a social media post by or on behalf of the at least one college athlete associated with the user transaction. The NIL application 132 can also provide increasingly detailed information as the user zooms or into data and/or navigates to data and objects displayed on the screen to reveal items of interest related to, for example, menu information and information related to particular college athletes.

In some implementations, the NIL application 132 can provide a unique directory providing a visual mechanism to search for categories of and items of interest (e.g., videos, audio, text, menu items, NIL information, etc.) or specific items within a particular venue (e.g., such as a restaurant). Search results can be presented on a graphical representation on the display screen with all search results. In some implementations, the information presented to the user through the user interface can be accessible by other applications and programs on the user's device such as e.g., user device 130.

The user device 130 and the server device 102 may be implemented as part of client/server network. That is, network 120 may be a client/server network that follows a client/server model, which is distributed application structure can partition tasks or workloads between the providers of a resource or service called a server, and service requesters, called clients. Clients and servers can communicate over a computer network on separate hardware but both client and server may reside in the same system. A server host can run one or more server programs, which can share their resources with clients. A client usually does not share any of its resources, but it can request content or service from a server. Clients, therefore, can initiate communication sessions with servers, which may await incoming requests. Network 120 may thus be the Internet and also be implemented as a wireless network (e.g., Wi-Fi, cellular etc.).

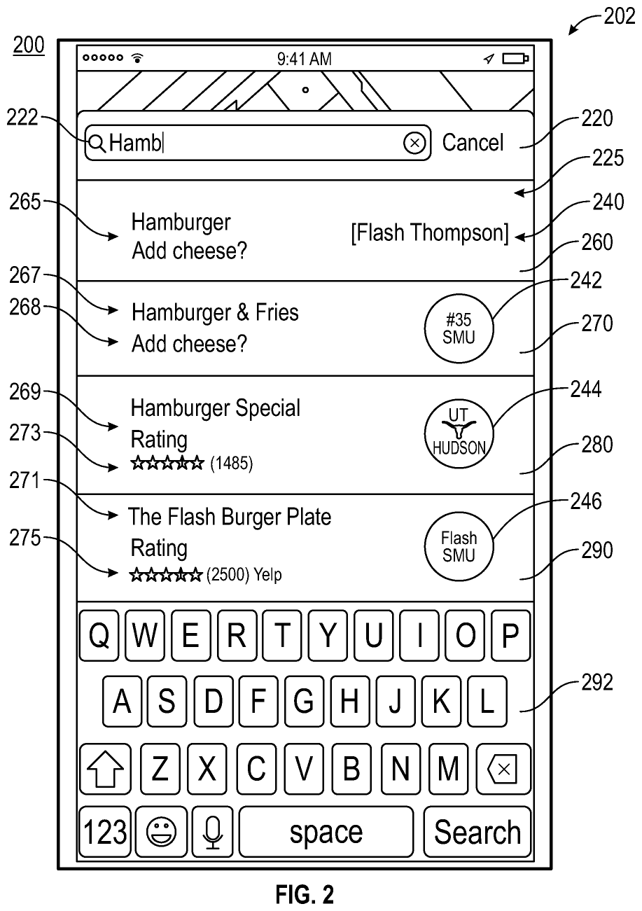

FIG. 2 illustrates an example graphical user interface 200 and screen 202 of NIL application 132 that can be presented on a display of user device 130, in accordance with an embodiment. The graphical user interface 200 can include a number of different GUI ‘screens’ such as the screen 202. In the example shown in FIG. 2, the screen 202 displayed by the graphical user interface 200 can provide for a manual search for a category of menu items in a menu (e.g., a restaurant menu) using the NIL application 132.

The graphical user interface 200 of the NIL application 132 can be presented to a display of user device 130 to initiate a manual search for a category of menu items using application 132. GUI 200 illustrates text being entered into field 222 to initiate a manual search for a category of menu items such as “Hamburger,” by way of example. In some implementations, map application 132 can use an auto-complete feature to suggest the menu item name. In the illustrated example, the user has not finished typing the search query, but the NIL application 132 has automatically completed the query and displays listing 225 of search results 260, 270, 280 and 290 for menu items that provide “Hamburger” (or variations thereof) that is populated as the user enters text into field 222.

Search result 260 can include a textual label 264 representing a menu item “Hamburger” with optional/associated text 265 that a user may select to “add cheese” to a menu order. The search result 260 also comprises an object 240 that can be displayed with the search result 260. The object 240 is displayed in the screen 202 of the GUI 200 in association with the particular menu item of “Hamburger” (i.e., the first textual label 264). The object 240 displayed can be representative of a NIL of a college athlete.

One or more objects such as object 240, object 242, object 244, and object 2460 can be displayed in the screen 202 of the GUI 200 in association with a particular menu item. The object 240, when selected by the user, allows the user to affiliate a NIL identifier with a user transaction (e.g., in this case, order food from a menu). The NIL identifier associated with object 240 is linked to a particular college athlete named Flash Thompson from SMU (Southern Methodist University).

The object 240 can be graphically presented in the GUI 200 as a textual object associated with the college athlete, Flash Thompson; hence, the name “Flash Thompson” as shown in FIG. 2. The name “Flash Thompson” is a NIL associated with SMU college athlete Flash Thompson. In some cases, the object 240 can be presented as a symbol, an image of a player, or a shape of a NIL representative of the college athlete. In the example of object 240, Flash Thompson's NIL is presented textually as his name and an object that is selectable by a user.

Additional search results can also be displayed in screen 202 of GUI 200 including, for example, a search result 270 with a textual label 267 (“Hamburger & Fries”) and with optional/associated text 268 that a user may select to “add cheese”. In this case, search result 270 is displayed below the search result 260. An object 242 is displayed with the search result 260. The object 242 is shown as “#35 SMU” which is a NIL associated with a college athlete who attends SMU and plays his/her sport with the number thirty-five. The object 240, when selected by the user, can allow the user to affiliate a NIL identifier with a user transaction (e.g., in this case, ordering “Hamburger & Fries” from a menu).

Search result 280, which can be displayed below the search result 270, can include a textual label 269 (“Hamburger Special”) and also an optional textual rating label 273, which can indicate the popularity of this particular menu item. In this case, the optional textual rating label 273 contains the word “Rating” along with five stars and the number of people (1485) who have rated this item at the displayed five star rating. The object 244 can be displayed with the search result 280 as a graphical element in the shape of or representative of a college athlete with the last name “Hudson” from the University of Texas (UT); hence, the graphically displayed Texas longhorn symbol/mascot can be included with the object 244. Thus, the object 244 is a NIL associated with a college athlete named Hudson from UT. The object 244 is a NIL associated with Hudson from UT.

Search result 290, which can be displayed below the search result 280, can display a textual label 271 (“The Flash Burger Plate”). The object 246 named “Flash SMU”) can also be displayed in association with or as a part of the search result 290. The object 246 can contain just the name “Flash”. This name, however, is also associated with the college athlete Flash Thompson from SMU as discussed above. The object 246 can be displayed in the GUI 200 in a shape of a NIL that is representative of college athlete Flash Thompson from SMU. The object 246 that when selected by the user, allows the user to affiliate the NIL identifier associated with Flash Thompson with the user transaction. An optional textual rating label 275, which can indicate the popularity of this particular menu item (i.e., “The Flash Burger Plate”). In this case, this menu item has a “Yelp” five-star rating and the number of people (2500) who have rated this item at the displayed five star rating using the Yelp mobile app. Note that “Yelp” is a trademark of Yelp Inc (a Delaware Corporation) of San Francisco, CA.

Although the embodiment shown in FIG. 2 depicts a textual search of the term ‘hamburger’ in field 222, it can be appreciated that a search can be made in the same field by a user, for example, for a particular college athlete. The NIL application 123 would then return search results for display in the screen 202 of all menu items associated with that particular college athlete searched. For example, if a user begins to enter the “Flash”, search results generated and displayed would include all objects associated with “Flash Thompson” in association with menu items that had been pre-associated with that college athlete.

Note that a virtual keyboard 292 can be provided by the GUI 200 for use in inputting data to the GUI 200 such as, for example, text entered into the field 222. The manual search described above with respect to field 222 can utilize the virtual keyboard 292.

In the embodiment depicted in FIG. 2, the GUI 200 can be implemented as part of or by a mobile application or “app” such as the NIL application 132. The NIL application 132 can incorporate features for ordering menu items from a menu. In an alternative embodiment, the NIL application 132 can be accessed by other mobile applications or may be incorporated into another mobile application. Likewise, the NIL application 132 can incorporate and function in association with other mobile “apps” or may incorporate features from other mobile “apps”.

An example of a mobile “app” that the NIL application 132 can communicate with and/or which may be incorporated by or incorporated into, is a restaurant ordering app. A non-limiting example of a restaurant ordering app is disclosed by U.S. Patent Application Publication No. 20200265508 entitled “Method and Apparatus for Facilitating Dining at an Eating Establishment,” which was published on Aug. 20, 2020, and which is incorporated herein by reference in its entirety. Another non-limiting example of a restaurant ordering app that can be adapted for use with an embodiment is disclosed in U.S. Pat. No. 11,037,254 entitled “Item Selection Based on User Interactions,” which issued on Jun. 15, 2021, and is incorporated herein by reference in its entirety.

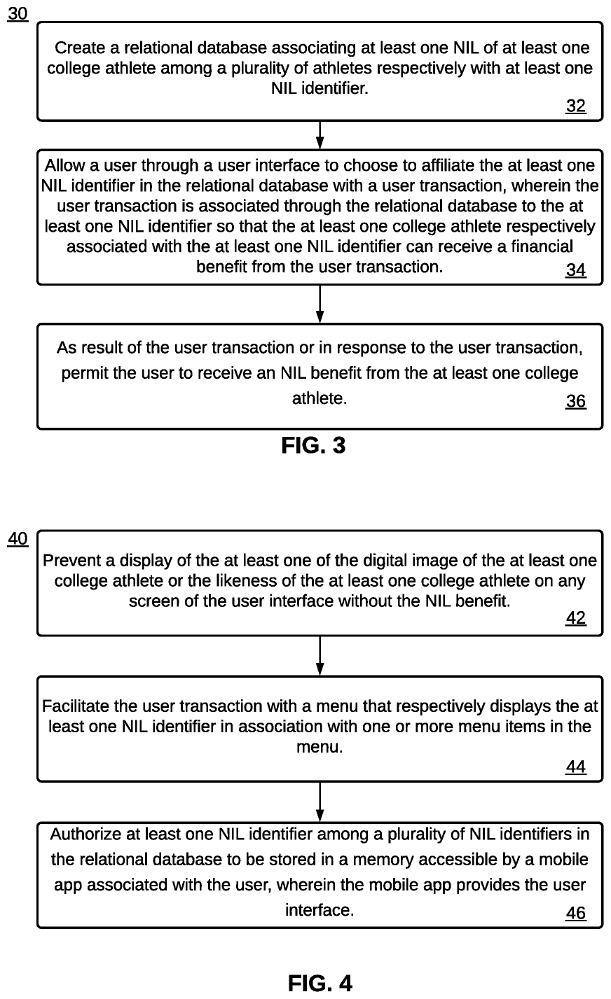

FIG. 3 illustrates a flow chart of operations depicting logical operational steps of a method 30 for providing a user with a proprietary asset corresponding to a name, image or likeness (NIL) of a college athlete, in accordance with an embodiment. It can be appreciated that the various steps, operations, or instructions depicted in the blocks in FIG. 3 and in other illustrations herein do not necessarily need to be performed in a particular order, although they can be performed in the illustrated order. In some embodiments, a step, operation or instruction illustrated and described herein with respect to a particular block can be performed in a different order than as illustrated in the figure or may be implemented separately apart from the other illustrated steps, operations or instructions shown in the blocks. Although a particular order of operations is shown in the figures, it can be appreciated that the various steps, operations or instructions may be performed out of sequence or in a different order.

As depicted at block 32 in FIG. 3, a step, operation or instruction can be implemented to create or build a relational database associating at least one NIL of at least one college athlete among a plurality of athletes respectively with at least one NIL identifier. Next, as depicted at block 34, a step, operation or instruction can be implemented to allow a user through a user interface to choose to affiliate the at least one NIL identifier in the relational database with a user transaction, wherein the user transaction is associated through the relational database to the at least one NIL identifier so that the at least one college athlete respectively associated with the at least one NIL identifier receives a financial benefit from the user transaction.

Thereafter, as indicated at block 36, a step, operation or instruction can be implemented to, as a result of the user transaction or in response to user transaction, permit the user to receive an NIL benefit from the at least one college athlete. The NIL benefit can comprise one or more of, for example, a non-fungible token image or likeness of the at least one college athlete, a digital image or likeness of the at least one college athlete, a communication from or on behalf of the at least one college athlete, clothing, a discount on the user transaction or future transactions, or a social media post by or on behalf of the at least one college athlete associated with the user transaction.

FIG. 4 illustrates a flow chart of operations depicting additional logical operational steps of a method 40 for providing a user with a proprietary asset corresponding to a name, image or likeness (NIL) of a college athlete, in accordance with an embodiment. One or more of the steps, operations, or instructions depicted in FIG. 4 with respect to the various blocks shown in FIG. 4 may be implemented in association with or in addition to the steps, operations/instructions of method 30 shown in FIG. 3.

As shown at block 42, a step, operation or instruction can be implemented to prevent a display of the at least one of the digital image of the at least one college athlete or the likeness of the at least one college athlete on any screen of the user interface without the NIL benefit. Then, as shown at block 44, a step, operation or instruction can be implemented to facilitate the user transaction with a menu that respectively displays the at least one NIL identifier in association with one or more menu items in the menu. Thereafter, as shown at block 46, a step, operation, or instruction can be implemented to authorize at least one NIL identifier among a plurality of NIL identifiers in the relational database to be stored in a memory accessible by a mobile app associated with the user, wherein the mobile app provides the user interface. Note that the terms ′“authorize,” “authorizing” or variations thereof such as “authorization” can relate to a security mechanism that can determine access levels or user/client privileges related to system resources including files, services, computer programs, data and application features. The terms ′“authorize” “authorizing” may involve authentication and/or encryption in some embodiments. The aforementioned security mechanism in some cases may involve a program or technique for validating a user/client or an action such as an electronic transaction.

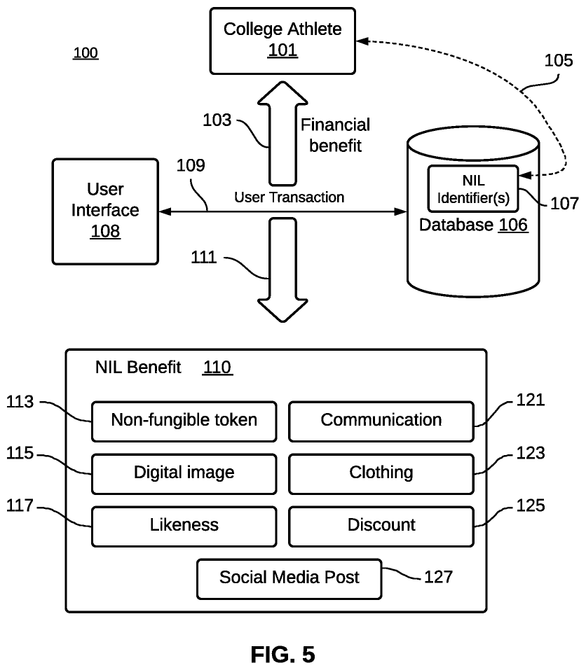

FIG. 5 illustrates a block diagram of the system 100 for providing a user with a proprietary asset corresponding to a name, image or likeness (NIL) of a college athlete, in accordance with an embodiment. The block diagram of system 100 shown in FIG. 5 is an alternative version of the system 100 shown in FIG. 1. That is, FIG. 5 depicts different aspects of the same system 100 depicted in FIG.

The relational database 106 can associate at least one NIL of at least one college athlete 101 among a plurality of athletes respectively with at least one NIL identifier. A user interface 108 can allow a user to choose to affiliate one or more NIL identifier(s) 107 in the relational database 106 with a user transaction 109. An example of user interface 108 is the graphical user interface 200 discussed earlier. The user interface 108 can be provided by the NIL application 132 also discussed above.

The user transaction 109 can be associated through the relational database 106 to the NIL identifier 107(s) so that the college athlete 101 respectively associated with the NIL identifier receives a financial benefit 103 from the user transaction 109. The association between the college athlete 101 and his or her unique NIL identifier 107 maintained in the relational database 106 is indicated by the dashed arrow 105 in FIG. 5.

As result of the user transaction 109 or in response to the user transaction 109 as indicated by arrow 111, the user is permitted to receive an NIL benefit 110 from the college athlete(s). The NIL benefit can comprise one or more of, for example, a non-fungible token image/likeness 113 of the college athlete, a digital image/ likeness 117 of the college athlete, a communication 121 from or on behalf of the college athlete 101, clothing, a discount 125 on the user transaction or future transactions, or a social media post 127 by or on behalf of the college athlete 101 associated with the user transaction.

In some embodiments, the relational database 106 can track the total number of NIL transactions and/or NIL benefits based on a cumulative number or value of the NIL transactions. Examples of a NIL transaction can include the user transaction 109, the financial benefit 103 to the college athlete 101, and/or the resulting NIL benefit 110 delivered to the user (e.g., a user of the client device 130).

The user interface 108 can provide one or more screens (e.g., such as screen 202) operable to display electronic content about the college athlete 101. The electronic content can include a NIL associated with the college athlete 101. The previously discussed objects 240, 242, 244, and 246 can display electronic content about the college athlete 101. The user interface 108 can graphically display the objects 240, 242, 244, and 246, which when selected by the user, as discussed previously herein, can allow the user to affiliate the NIL identifier(s) 107 with the user transaction 109.

In some embodiments, each object 240, 242, 244, and/or 246 can occupy a user-specified location on a screen of the user interface 108 and/or occupy a user specified area of the user interface 108. For example, the object 240 representative of the name of Flash Thompson is shown at the right hand side of the screen 202. The user can choose a setting in NIL application 132 to specify a different location or area in the user interface where the object can be located. For example, a user may want the object 240 to be displayed to the left of the textual label 264 and optional/associated text 265, rather than to the right as shown in FIG. 2.

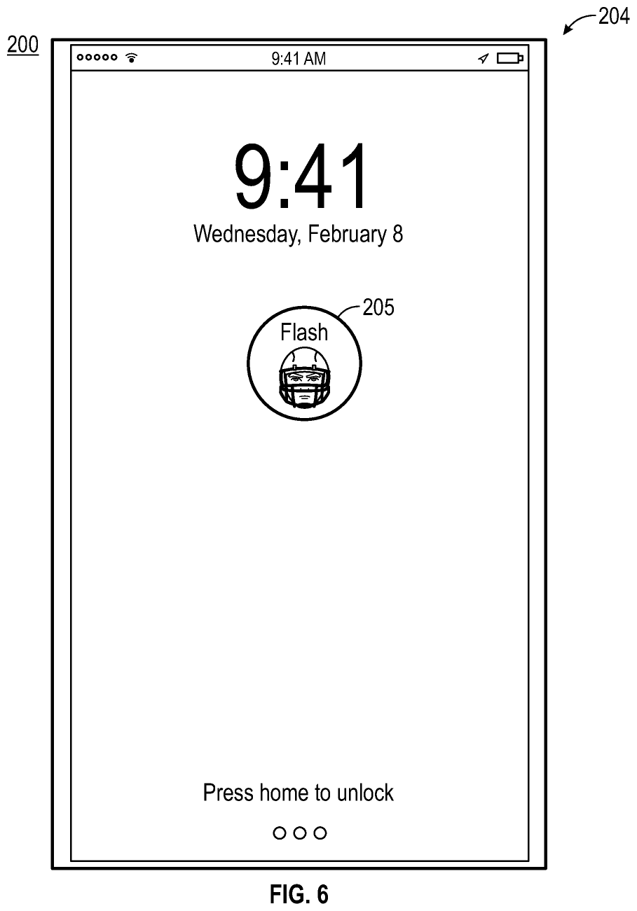

FIG. 6 illustrates an example graphical user interface 200 and screen 204 of NIL application 132 that can be presented on a display of user device 130, in accordance with an embodiment. The screen 204 is a ‘lock screen’. In the example screen 204, an object 204 can be displayed. The object 204 can comprise a NIL benefit. That is, the object 204 can include an image or likeness of the college athlete 101 and as part of the NIL benefit can be displayable on the lock screen 204 of the graphical user interface 200.

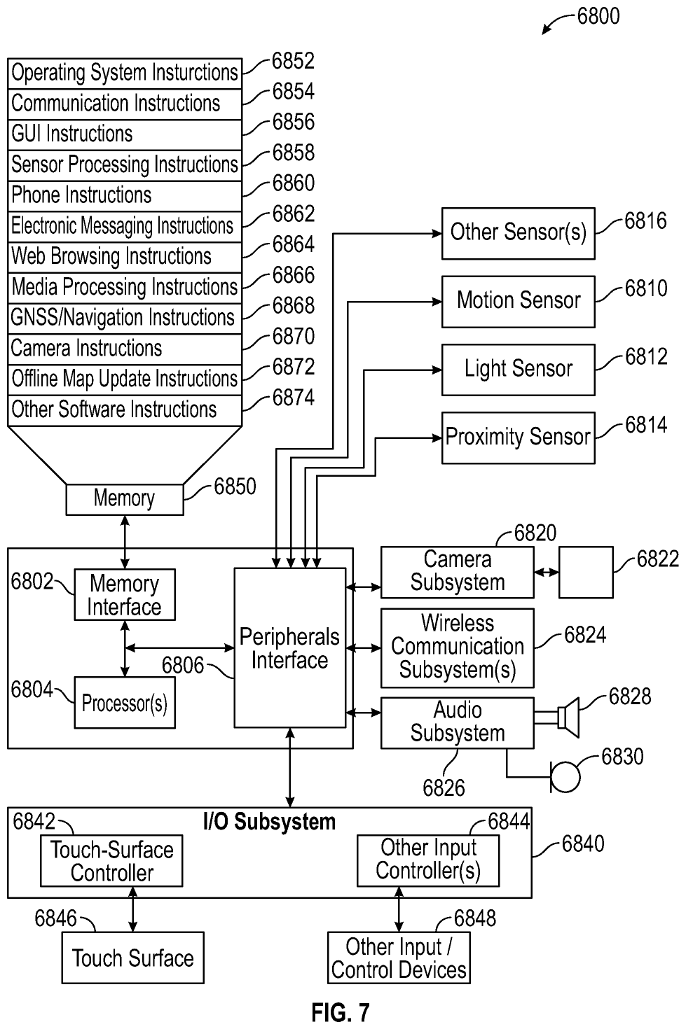

FIG. 7 illustrates a block diagram of an example computing device 6800 that can implement the features, methods, systems, and processes of FIGS. 1-6. The computing device 6800 can include a memory interface 6802, one or more data processors, image processors and/or central processing units 6804, and a peripherals interface 6806. The memory interface 6802, the one or more processors 6804 and/or the peripherals interface 6806 can be separate components or can be integrated in one or more integrated circuits. The various components in the computing device 6800 can be coupled by one or more communication buses or signal lines.

Sensors, devices, and subsystems can be coupled to the peripherals interface 6806 to facilitate multiple functionalities. For example, a motion sensor 6810, a light sensor 6812, and a proximity sensor 6814 can be coupled to the peripherals interface 6806 to facilitate orientation, lighting, and proximity functions. Other sensors 6816 can also be connected to the peripherals interface 6806, such as a global navigation satellite system (GNSS) (e.g., GPS receiver), a temperature sensor, a biometric sensor, magnetometer or other sensing device, to facilitate related functionalities.

A camera subsystem 6820 and an optical sensor 6822, e.g., a charged coupled device (CCD) or a complementary metal-oxide semiconductor (CMOS) optical sensor, can be utilized to facilitate camera functions, such as recording photographs and video clips. The camera subsystem 6820 and the optical sensor 6822 can be used to collect images of a user to be used during authentication of a user, e.g., by performing facial recognition analysis.

Communication functions can be facilitated through one or more wireless communication subsystems 6824, which can include radio frequency receivers and transmitters and/or optical (e.g., infrared) receivers and transmitters. The specific design and implementation of the communication subsystem 6824 can depend on the communication network(s) over which the computing device 6800 is intended to operate. For example, the computing device 6800 can include communication subsystems 6824 designed to operate over a GSM network, a GPRS network, an EDGE network, a Wi-Fi or WiMax network, and a Bluetooth™ network. In particular, the wireless communication subsystems 6824 can include hosting protocols such that the device 130 can be configured as a base station for other wireless devices.

An audio subsystem 6826 can be coupled to a speaker 6828 and a microphone 6830 to facilitate voice-enabled functions, such as speaker recognition, voice replication, digital recording, and telephony functions. The audio subsystem 6826 can be configured to facilitate processing voice commands, voiceprinting and voice authentication, for example.

The I/O subsystem 6840 can include a touch-surface controller 6842 and/or other input controller(s) 6844. The touch-surface controller 6842 can be coupled to a touch surface 6846. The touch surface 6846 and touch-surface controller 6842 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 6846.

The other input controller(s) 6844 can be coupled to other input/control devices 6848, such as one or more buttons, rocker switches, thumb-wheel, infrared port, USB port, and/or a pointer device such as a stylus. The one or more buttons (not shown) can include an up/down button for volume control of the speaker 6828 and/or the microphone 6830.

In one implementation, a pressing of the button for a first duration can disengage a lock of the touch surface 6846; and a pressing of the button for a second duration that is longer than the first duration can turn power to the computing device 6800 on or off. Pressing the button for a third duration can activate a voice control, or voice command, module that enables the user to speak commands into the microphone 6830 to cause the device to execute the spoken command. The user can customize a functionality of one or more of the buttons. The touch surface 6846 can, for example, also be used to implement virtual or soft buttons and/or a keyboard.

In some implementations, the computing device 6800 can present recorded audio and/or video files, such as MP3, AAC, and MPEG files. In some implementations, the computing device 6800 can include the functionality of an MP3 player, such as available through modern smartphones and other portable computing devices (e.g., tablet computing devices). The computing device 6800 can, therefore, include a 36-pin connector that is compatible with the portable computing device. Other input/output and control devices can also be used. Note that in some situations, the computing device 6800 can be the user device 130 and/or the server device 102.

The memory interface 6802 can be coupled to memory 6850. The memory 6850 can include high-speed random access memory and/or non-volatile memory, such as one or more magnetic disk storage devices, one or more optical storage devices, and/or flash memory (e.g., NAND, NOR). The memory 6850 can store an operating system 6852, such as Darwin, RTXC, LINUX, UNIX, OS X, WINDOWS, or an embedded operating system such as VxWorks.

The operating system 6852 can include instructions for handling basic system services and for performing hardware dependent tasks. In some implementations, the operating system 6852 can be a kernel (e.g., UNIX kernel). In some implementations, the operating system 6852 can include instructions for performing voice authentication. For example, operating system 6852 can implement the NIL application 132 features as described with reference to FIGS. 1-6.

The memory 6850 can also store communication instructions 6854 to facilitate communicating with one or more additional devices, one or more computers and/or one or more servers. The memory 6850 can include graphical user interface instructions 6856 to facilitate graphic user interface processing; sensor processing instructions 6858 to facilitate sensor-related processing and functions; phone instructions 6860 to facilitate phone-related processes and functions; electronic messaging instructions 6862 to facilitate electronic-messaging related processes and functions; web browsing instructions 6864 to facilitate web browsing-related processes and functions; media processing instructions 6866 to facilitate media processing-related processes and functions; GNSS/Navigation instructions 6868 to facilitate GNSS and navigation-related processes and instructions; and/or camera instructions 6870 to facilitate camera-related processes and functions.

The memory 6850 can store other software instructions 6872 to facilitate other processes and functions, such as the venue and indoor map processes and functions as described with reference to FIGS. 1-6 and FIGS. 8-9.

The memory 6850 can also store other software instructions 6874, such as web video instructions to facilitate web video-related processes and functions; and/or web shopping instructions to facilitate web shopping-related processes and functions. In some implementations, the media processing instructions 6866 are divided into audio processing instructions and video processing instructions to facilitate audio processing-related processes and functions and video processing-related processes and functions, respectively.

Each of the above identified instructions and applications can correspond to a set of instructions for performing one or more functions described above. Examples of instructions include the various steps, operations or instructions discussed herein with respect to FIG. 3 and FIG. 4 and elsewhere herein. These instructions need not be implemented as separate software programs, procedures, or modules. The memory 6850 can include additional instructions or fewer instructions. Furthermore, various functions of the computing device 6800 can be implemented in hardware and/or in software, including in one or more signal processing and/or application specific integrated circuits.

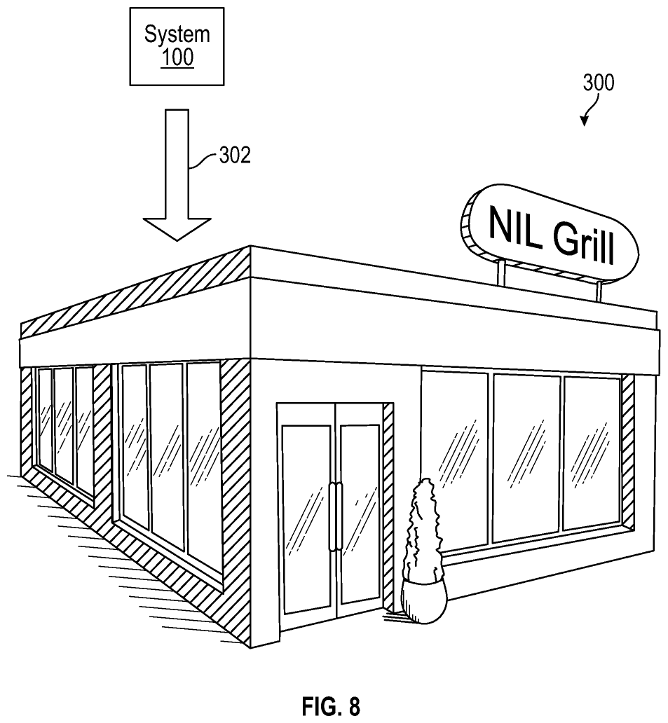

FIG. 8 illustrates a schematic diagram of the system 100 for providing a user with a proprietary asset corresponding to a NIL, as applied to a restaurant 300, in accordance with an embodiment. In the example show in FIG. 8, the NIL system 100 can be implemented in the context of a restaurant 300 called the “NIL Grill”. As discussed previously, the NCAA now allows college athletes to profit from the use of their NIL, while maintain their amateur status as NCAA scholarship athletes. Some college athletes are already making a great deal of money. However, the vast majority of college athletes currently make little or nothing. Thus, the system 100 provides a way for some players who may not be ‘all-stars’ paid to provide value to a payor. System 100 thus provides a mechanism for a business linking the purchase of its products or services, an order for its products or its services, or a visit to a business location to provide a payment to a college athlete of the consumer's or customer's choice.

The NIL Grill concept shown in FIG. 8 offers one potential approach for providing a user with a proprietary asset corresponding to a NIL. The user may be, for example, a consumer or customer of a business. In the embodiment depicted in FIG. 8, the user may be a customer of the restaurant 300. The ‘NIL Grill’ may be a sports bar, or restaurant in a college town, for example, that can offer one or a combination of the following:
1.) Individual menu offerings a fan can purchase that the fan knows is tied to a player so the fan knows the player will get a set amount, a percentage amount or some other form of compensation for the fan buying the menu item. For example, if an SMU fan wants to reward Tanner Mordecai for throwing 5 TDs this week, they can order the Mordecai Nachos.
2.) Order tying is another option. A fan can order their food and in doing so designate which player from a menu they want paid a fixed amount or percentage of their order price. A sports bar in Tuscaloosa, Alabama, for example, that has this feature could draw thousands who want to make sure the Crimson Tide is paying its players enough to attract the best talent.

The concept can be refined to add more. For example, if the Fan/Customer (i.e., the user) wants to let the player know they supported them, the player can get an email from the NIL Grill telling them that Fan A supported them. This could trigger a response video or email from the player thanking the fan, pre-recorded or live, the player can decide based upon their response to the email or text from the NIL Grill. Multiple video thankyous can be recorded that vary be order items, amounts, etc. These can serve as mini-ads for the restaurant as well.

The NIL Grill could also have a gift shop with NIL merch, school merch and other items where again the Fan customer can choose which player gets a piece of their order or buy things with the name, image and likeness of the players they want to support.

The system 100 claims can also allow merchants in any area to become “NIL Certified” in that they can advertise that Fan customers have the option to buy from them and support their favorite players who will get a percentage or fixed fee from every purchase—cars, A/C systems, boats, furniture, mattresses, car washes etc. The business can then again use thank you messages or videos from the players as follow on advertising of their business. If the process is licensed to a single business in a state, region or city, the business can become the place to go to support the team, giving the business a bigger advantage than if they advertised at a stadium alone. The Fans want to help their team buy the best players and this is how to do it. Tying purchases of individual items or orders to NIL payments and then adding in all of the advertising opportunities, messaging, etc. can create a licensing model for millions of businesses in college markets or owned by alumna who want to support their teams.

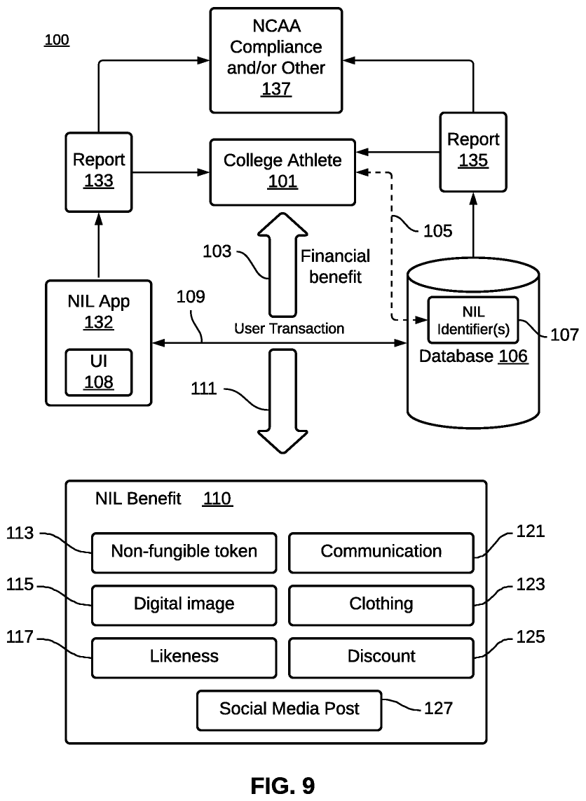

FIG. 9 illustrates a block diagram of the system 100, in accordance with an alternative embodiment. The system 100 depicted in FIG. 9 illustrates a slightly different embodiment from that shown in FIG. 5. In the embodiment of system 100 depicted in FIG. 9, the database 106 and/or the NIP application 132 can generate a report that can be sent (e.g., email, text message, social media messaging, etc.) to the college athlete 101 and or any other entity 137 where reporting on such activity may be required (e.g., NCAA compliance/other). This can enable the system 100 to be extremely easy for the college athlete 101 to comply with any reporting obligations. In the example shown in FIG. 9, a report 133 can be generated by the NIL app 132 and sent directly to the college athlete and/or to the entity 137. A similar report 135 can be generated by the relational database 106 and sent to the college athlete 101 and/or the entity 137.

Note that the communication 121 depicted in FIG. 5 and FIG. 9 can be implemented in the form of a NIL benefit comprising a pre-determined and pre-recorded message from the college athlete 101. In other words, the user gets the NIL benefit stored in the system 100 associated with the type of user transaction. For example, if a user (e.g., customer/consumer) spends $25 at a car wash, the system 100 can automatically generate a thank you email from the player, and this thank you message (i.e., a NIL benefit) can also include advertisements from the car wash, future coupons or other advertising materials. If the user reaches a certain level of transactions (e.g., amount, number, value, etc.) the automatically generated benefits (i.e., NIL benefits) can increase in value or become more personalized, such as by a social media post from the player thanking the user, etc. The NIL benefit 110 that the user receives can be just from the player, can be from the player with ads, can be from the player with coupons, can be from the player with anything the transaction merchant wants to tack on as part of the player/user engagement process.

In some embodiments, it may be desirable to validate the user transaction 109 (e.g., an electronic transaction) and/or the user/customer. A non-limiting approach, which can be adapted for use with an embodiment to validate the user transaction 109 is disclosed in U.S. Patent Application Publication No. 20200380509 entitled “Validating Customer in an Electronic Transaction,” which was published on Dec. 3, 2020 and is incorporated herein by reference in its entirety. Another non-limiting approach for validating the user transaction 109 (e.g., an electronic transaction) and/or the user/customer is disclosed in U.S. Patent No. 20200250665 entitled “Blockchain-based electronic transaction system free of sales platform and method thereof,” which was published on Aug. 6, 2020 and is incorporated herein by reference in its entirety.

The NIL application 132 can provide a user with a proprietary asset corresponding to a NIL (or NILs) of the college athlete 101 (or college athletes). The NIL application 132 is operable to allow a user through the user interface 108 to choose to affiliate one or more NIL identifiers 107 in the relational database 106 with the user transaction 109. The user transaction 109 can be associated through the relational database 106 to the NIL identifier 107 so that the college athlete 101 can respectively associated with the NIL identifier 107 can receive a financial benefit from the user transaction 109. As a result of the user transaction 109 or in response to the user transaction 109, the user can be permitted to receive the NIL benefit 110 from the college athlete 101.

Although the database 106 has been described as being a relational database. It can be appreciated that other types of databases may be utilized in place of a relational database to implement the database 106 in alternative embodiments. Examples of databases that can be implemented with alternative embodiments in place of a relational database include in-memory databases, Hadoop/NoSQL databases, virtualized databases, columnar databases, and streaming databases to name a few.

Based on the foregoing, it can be appreciated that a number of varying embodiments are disclosed herein. For example, in an embodiment, a method for providing a user with a proprietary asset corresponding to a name, image or likeness (NIL) of a college athlete, can involve: creating a relational database associating at least one NIL of at least one college athlete among a plurality of athletes respectively with at least one NIL identifier; allowing a user through a user interface to choose to affiliate the at least one NIL identifier in the relational database with a user transaction, wherein the user transaction is associated through the relational database to the at least one NIL identifier so that the at least one college athlete respectively associated with the at least one NIL identifier receives a financial benefit from or associated with the user transaction; and as a result of the user transaction, permitting the user to receive an NIL benefit from the at least one college athlete, the NIL benefit including at least one of: a non-fungible token image or likeness of the at least one college athlete, a digital image or likeness of the at least one college athlete, a communication from or on behalf of the at least one college athlete, an autograph, clothing, a discount on the user transaction or future transactions, or a social media post by or on behalf of the at least one college athlete associated with the user transaction.

In an embodiment, the relational database is operable to track a total number of NIL transactions and/or NIL benefits based on a cumulative number or value of the NIL transactions.

In an embodiment, the user interface can provide at least one screen operable to display electronic content about the at least one college athlete, the electronic content including a NIL associated with the at least one college athlete.

In an embodiment, the user interface can graphically display an object that when selected by the user, allows the user to affiliate the at least one NIL identifier with the user transaction.

In an embodiment, the object can be displayed in the user interface in a shape of a NIL representative of the at least one college athlete.

In an embodiment, the object can occupy a user-specified location on a screen of the user interface and/or can occupy a user specified area of the user interface.

In an embodiment, the NIL benefit may comprise at least one of the digital image of the athlete or the likeness of the at least one college athlete is displayable on a lock screen of the user interface.

An embodiment can further involve preventing a display of the at least one of the digital image of the at least one college athlete or the likeness of the at least one college athlete on any screen of the user interface without the NIL benefit.

An embodiment can further involve facilitating the user transaction with a menu that respectively displays the at least one NIL identifier in association with one or more menu items in the menu.

An embodiment can further involve authorizing at least one NIL identifier among a plurality of NIL identifiers in the relational database to be stored in a memory accessible by a mobile app associated with the user, wherein the mobile app provides the user interface.

In an embodiment, the user transaction can comprise at least one of: a past transaction or a current transaction.

In an embodiment, the communication from or on behalf of the at least one college athlete can comprise a pre-determined and pre-recorded message from the at least one college athlete.

In an embodiment, a method for providing a user with a proprietary asset corresponding to a name, image or likeness (NIL) of a college athlete, can involve: allowing a user through a user interface to choose to affiliate at least one NIL identifier in a relational database with a user transaction, wherein the user transaction is associated through the relational database to the at least one NIL identifier so that at least one college athlete respectively associated with the at least one NIL identifier receives a financial benefit from the user transaction; and as a result of the user transaction, permitting the user to receive an NIL benefit from the at least one college athlete, the NIL benefit including at least one of: a non-fungible token image of the at least one college athlete, a digital image of the at least one college athlete, a likeness of the at least one college athlete, a communication from or on behalf of the at least one college athlete, clothing, a discount on the user transaction or future transactions, or a social media post by or on behalf of the at least one college athlete associated with the user transaction.

An embodiment can further involve creating the relational database associating at least one NIL of the at least one college athlete among the plurality of athletes respectively with the at least one NIL identifier.

In an embodiment, the relational database can track a total number of NIL transactions and/or NIL benefits based on a cumulative number or value of NIL transactions.

In an embodiment, the user interface can provide at least one screen operable to display electronic content about the at least one college athlete, the electronic content including a NIL associated with the at least one college athlete.

In an embodiment, the user interface can graphically display an object that when selected by the user, allows the user to affiliate the at least one NIL identifier with the user transaction.

In an embodiment, the object can be displayed in the user interface in a shape of a NIL representative of the at least one college athlete.

In an embodiment, the object may occupy a user-specified location on a screen of the user interface and/or can occupy a user specified area of the user interface.

In an embodiment, the NIL benefit can comprise at least one of the digital image of the athlete or the likeness of the at least one college athlete is displayable on a lock screen of the user interface.

An embodiment can further involve preventing a display of the at least one of the digital image of the at least one college athlete or the likeness of the at least one college athlete on any screen of the user interface without the NIL benefit.

An embodiment may further involve facilitating the user transaction with a menu that respectively displays the at least one NIL identifier in association with one or more menu items in the menu.

An embodiment may further involve authorizing at least one NIL identifier among a plurality of NIL identifiers in the relational database to be stored in a memory accessible by a mobile app associated with the user, wherein the mobile app provides the user interface.

In an embodiment, the user transaction may comprise at least one of: a past transaction or a current transaction.

In an embodiment, a system for providing a user with a proprietary asset corresponding to a name, image or likeness (NIL) of a college athlete, can include: a relational database associating at least one NIL of at least one college athlete among a plurality of athletes respectively with at least one NIL identifier; a user interface, wherein a user is allowed through the user interface to choose to affiliate the at least one NIL identifier in the relational database with a user transaction, wherein the user transaction is associated through the relational database to the at least one NIL identifier so that the at least one college athlete respectively associated with the at least one NIL identifier receives a financial benefit from the user transaction; and an NIL benefit, wherein as a result of the user transaction, the user is permitted to receive an NIL benefit from the at least one college athlete, the NIL benefit including at least one of: a non-fungible token image or likeness of the at least one college athlete, a digital image or likeness of the at least one college athlete, a communication from or on behalf of the at least one college athlete, clothing, a discount on the user transaction or future transactions, or a social media post by or on behalf of the at least one college athlete associated with the user transaction.

In an embodiment, a system for providing a user with a proprietary asset corresponding to a name, image or likeness (NIL) of a college athlete, can include at least one processor and at least one memory storing at least one program for execution by the at least one processor, the at least one processor including instructions for: creating a relational database associating at least one NIL of at least one college athlete among a plurality of athletes respectively with at least one NIL identifier; allowing a user through a user interface to choose to affiliate the at least one NIL identifier in the relational database with a user transaction, wherein the user transaction is associated through the relational database to the at least one NIL identifier so that the at least one college athlete respectively associated with the at least one NIL identifier receives a financial benefit from the user transaction; and as a result of the user transaction, permitting the user to receive an NIL benefit from the at least one college athlete, the NIL benefit including at least one of: a non-fungible token image or likeness of the at least one college athlete, a digital image or likeness of the at least one college athlete, a communication from or on behalf of the at least one college athlete, clothing, a discount on the user transaction or future transactions, or a social media post by or on behalf of the at least one college athlete associated with the user transaction.

In an embodiment, a credit card/debit card may be used, which instead of paying cash back to the user, pays an NIL benefit to a player. The player may provide the user an NIL benefit one time when they set up theft credit/debit card to benefit the player. The player may also provide the user an NIL benefit for each transaction. In addition, the player may provide the user an NIL benefit as certain levels of NIL payments are received by the player.

In an embodiment, the disclosed system may produce an NIL report that includes a detailed listing or a summary of all NIL transactions when requested or when scheduled. This NIL report may be automatically sent to any regulatory bodies and the school (e.g., university or high school) for compliance purposes. Furthermore, the NIL report may be automatically sent to the student athlete.

In an embodiment, a business can become part of a network of businesses where when an NIL credit/debit card is used, discounts or some other form of benefits may be automatically applied to the user transaction.

It should be appreciated that the embodiments do not require the same user who selects a NIL IDs in the user interface to be the same user who later transacts. For example, if a user who selects a wide receiver associated with a particular university, but then the user's spouses uses the aforementioned credit card in the transaction, then the user can receive, for example, a NIL message. In other words, the user can select the NIL ID to link to a present transaction or a future transaction, meaning that the transaction can be conducted by anybody with the return of an NIL benefit.

Additionally, the embodiments can be configured to automatically create reports of NIL payments, who contributed, etc. The embodiments can allow for scenarios in which when multiple athletes are selected for the user, the contributed NIL benefits can be divided, for example, by percentages, types of transactions, dares of transactions and these selections can be changed by the user as to future transactions and future changes can be scheduled.

It will be appreciated that variations of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which are also intended to be encompassed by the following claims.

What is claimed is:

1. A method for providing a user with a proprietary asset corresponding to a name, image or likeness (NIL) of a college athlete, comprising:
creating a relational database associating at least one NIL with at least one college athlete, and identifying the at least one NIL with at least one NIL identifier (NIL ID) unique to the at least one college athlete;
allowing a user through a user interface to select the at least one NIL ID to affiliate with at least one present transaction or at least one future transaction, wherein the at least one present transaction or the at least one future transaction when completed is credited to the selected at least one NIL ID so that the at least one college athlete associated with the at least NIL ID receives something of value from or associated with the at least one present transaction or the at least one future transaction upon or after completion of the at least one present transaction or the at least one future transaction; and
as a result of the completion of the at least one present transaction or the at least one future transaction, permitting the user to receive an NIL benefit from the at least one college athlete, the NIL benefit including at least one of: a non-fungible token image or likeness of the at least one college athlete, a digital image or likeness of the at least one college athlete, a communication from or on behalf of the at least one college athlete, a social media post by the at least one college athlete, an autograph, clothing, a discount on the at least one present transaction or the at least one future transaction, or a social media post by or on behalf of the at least one college athlete associated with the at least one present transaction or the at least one future transaction.

2. The method of claim 1 wherein the relational database is operable to track a total number of NIL transactions and/or NIL benefits based on a cumulative number or value of the NIL transactions, wherein the NIL transactions comprise the at least one present transaction and/or the at least one future transaction.

3. The method of claim 1 wherein the user interface provides at least one screen operable to display electronic content about the at least one college athlete, the electronic content including a NIL associated with the at least one college athlete.

4. The method of claim 1 wherein the user interface graphically displays an object that when selected by the user, allows the user to affiliate the at least one NIL identifier with the at least one present transaction or the at least one future transaction.

5. The method of claim 4 wherein the object is displayed in the user interface in a shape of a NIL representative of the at least one college athlete.

6. The method of claim 4 wherein the object occupies a user-specified location on a screen of the user interface and/or occupies a user specified area of the user interface.

7. The method of claim 1 wherein the NIL benefit comprising at least one of the digital image of the athlete or the likeness of the at least one college athlete is displayable on a lock screen of the user interface.

8. The method of claim 1 further comprising preventing a display of the at least one of the digital image of the at least one college athlete or the likeness of the at least one college athlete on any screen of the user interface without the NIL benefit.

9. The method of claim 1 further comprising facilitating the at least one present transaction or the at least one future transaction with a graphically displayed menu that respectively displays the at least one NIL identifier in association with one or more menu items in the graphically displayed menu.

10. The method of claim 1 further comprising authorizing at least one NIL identifier among a plurality of NIL identifiers in the relational database to be stored in a memory accessible by a mobile app associated with the user, wherein the mobile app provides the user interface.

11. The method of claim 1 wherein the communication from or on behalf of the at least one college athlete comprises a pre-determined and pre-recorded message from the at least one college athlete.

12. A method for providing a user with a proprietary asset corresponding to a name, image or likeness (NIL) of a college athlete, comprising:
allowing a user through a user interface to choose to affiliate at least one NIL identifier in a relational database with a user transaction, wherein the user transaction is associated through the relational database to the at least one NIL identifier so that at least one college athlete respectively associated with the at least one NIL identifier receives a financial benefit from the user transaction; and
as a result of the user transaction, permitting the user to receive an NIL benefit from the at least one college athlete, the NIL benefit including at least one of: a non-fungible token image of the at least one college athlete, a digital image of the at least one college athlete, a likeness of the at least one college athlete, a communication from or on behalf of the at least one college athlete, clothing, a discount on the user transaction or future transactions, or a social media post by or on behalf of the at least one college athlete associated with the user transaction.

13. The method of claim 12 further comprising creating the relational database associating at least one NIL of the at least one college athlete among the plurality of athletes respectively with the at least one NIL identifier.

14. The method of claim 12 wherein the relational database tracks a total number of NIL transactions and/or NIL benefits based on a cumulative number or value of NIL transactions.

15. The method of claim 12 wherein the user interface provides at least one screen operable to display electronic content about the at least one college athlete, the electronic content including a NIL associated with the at least one college athlete.

16. The method of claim 12 wherein the user interface graphically displays an object that when selected by the user, allows the user to affiliate the at least one NIL identifier with the user transaction, wherein the object occupies a user-specified location on a screen of the user interface and/or occupies a user specified area of the user interface.

17. A system for providing a user with a proprietary asset corresponding to a name, image or likeness (NIL) of a college athlete, comprising:
a relational database that associates at least one NIL with at least one college athlete, and identifying the at least one NIL with at least one NIL identifier (NIL ID) unique to the at least one college athlete;
a user interface that allows a user through the user interface to select the at least one NIL ID to affiliate with at least one present transaction or at least one future transaction, wherein the at least one present transaction or the at least one future transaction when completed is credited to the selected at least one NIL ID so that the at least one college athlete associated with the at least NIL ID receives something of value from or associated with the at least one present transaction or the at least one future transaction upon or after completion of the at least one present transaction or the at least one future transaction; and
wherein as a result of the completion of the at least one present transaction or the at least one future transaction, the user is permitted to receive an NIL benefit from the at least one college athlete, the NIL benefit including at least one of: a non-fungible token image or likeness of the at least one college athlete, a digital image or likeness of the at least one college athlete, a communication from or on behalf of the at least one college athlete, a social media post by the at least one college athlete, an autograph, clothing, a discount on the at least one present transaction or the at least one future transaction, or a social media post by or on behalf of the at least one college athlete associated with the at least one present transaction or the at least one future transaction.
